(19) United States
(12) Patent Application Publication
(10) Pub. No.: US 2025/0028971 A1
(43) Pub. Date: Jan. 23, 2025

(54) SYSTEMS AND METHODS FOR FEDERATED LEARNING

(71) Applicant: Capital One Services, LLC, McLean, VA (US)

(72) Inventors: Jeremy GOODSITT, Champaign, IL (US); Michael DAVIS, Arlington, VA (US); Kenny BEAN, Herndon, VA (US); Tyler FARNAN, San Diego, CA (US); Taylor TURNER, Richmond, VA (US)

(73) Assignee: Capital One Services, LLC, McLean, VA (US)

(21) Appl. No.: 18/357,086

(22) Filed: Jul. 21, 2023

(51) Int. Cl. G06N 3/098

(52) U.S. Cl. CPC G06N 3/098

(57) ABSTRACT

Systems and methods for federated learning including validation of training data on client devices before training models based on the training data. In some aspects, the system accesses local data to be used for training a local model on a client device. The system generates event metadata corresponding to events in the local data. The event metadata is based on validation data received from an external server. The validation data is inaccessible to a central server. The system determines to exclude a portion of the local data that is not validated by the event metadata and generates validated local data. The system trains the local model based on the validated local data. The system processes, using a data de-identification function, the event metadata to generate de-identified event metadata. The system transmits the local model and the de-identified event metadata to the central server.

### SUMMARY

In recent years, the use of artificial intelligence, including, but not limited to, machine learning, deep learning, etc. (referred to collectively herein as artificial intelligence models, machine learning models, or simply models), has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. Federated machine learning is a machine learning technique in which the algorithm trains across multiple decentralized edge devices with local data samples without sending training data back to a central training server. This allows client devices to train a shared machine learning model while keeping all the training data local. Each client device downloads the shared machine learning model and retrains or updates the model using local training data. Each device then sends an updated set of model weights to the cloud (e.g., a central system), which is merged with other client device updates to improve the shared model. However, federated machine learning is not without challenges. In particular, current federated learning systems do not validate local data on a client device prior to training a local model in a federated learning environment. Such validation is particularly challenging in circumstances where data confidentiality is to be maintained for local training data at the client device.

Methods and systems are described herein for novel uses and/or improvements to artificial intelligence applications and in particular to federated machine learning techniques. Inaccurate training data may be introduced maliciously in an attempt to sabotage the training process. Alternatively, data can be corrupted on the client device due to hardware or software problems resulting in processing or storage errors. As one example, methods and systems are described herein for preventing training a local model using inaccurate training data in a federated learning environment by corroborating client device data. Methods and systems prevent training a local model using inaccurate training data by comparing it to external datasets locally and externally, which ensures the accuracy of the training data and subsequently improves the accuracy of the model.

Existing systems fail to perform validation on the local data to ensure the accuracy of the data used to train the local model on the client device in federated learning environments. For example, existing systems do not validate user data using external sources because of the variety of data that needs verification and the confidentiality requirement of federated learning environments. For example, transaction data needs to be verified by extracting de-identified metadata from the client device and comparing the de-identified metadata with external data to ensure the accuracy of the training data on the client device. However, adapting artificial intelligence models for this practical benefit faces several technical challenges such as how to corroborate local device data and simultaneously refrain from transmitting the sensitive data to a centralized server to preserve data confidentiality.

To overcome these technical deficiencies in adapting artificial intelligence models for this practical benefit, methods and systems disclosed herein identify relevant portions of a dataset to prompt extraction of de-identified metadata from a client device corresponding to an external database. For example, the system uses metadata from an external source to corroborate and validate local training data on the client device. The metadata is likely unique to the client device and therefore can be used to validate the local data. Accordingly, by corroborating client device data, the methods and systems provide the benefit of preventing a client device from using inaccurate training data to train a local model in a federated learning environment. Preventing a client device from using inaccurate training data to train a local model helps to improve the accuracy of the global model training on the central server. Improving the accuracy of the global model increases the accuracy of the global model results and ensures that the model is not trained on data that is inaccurate.

In some aspects, the methods and systems describe federated learning including validation of training data on client devices before or in conjunction with training models based on the training data. For example, the system may access local data to be used for training a local model on a client device. The system may generate, based on first validation data received from a first external server, event metadata corresponding to events in the local data, wherein the first validation data is related to the events in the local data, and wherein the first validation data is inaccessible to a central server. The system may, based on comparing the local data and the event metadata, determine to exclude a portion of the local data that is not validated by the event metadata and generate validated local data. The system may train the local model based on the validated local data. The system may process, using a data de-identification function, the event metadata to generate de-identified event metadata. The system may transmit the local model and the de-identified event metadata to the central server.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for ensuring the accuracy of training data and improving the accuracy of the model in federated learning environments, in accordance with one or more embodiments.

FIG. 2 shows an illustrative data flow diagram for validating local data on a client device prior to training, in accordance with one or more embodiments.

FIG. 3 shows illustrative components for a system used to prevent a client device from using inaccurate training data to train a local model in a federated learning environment, in accordance with one or more embodiments.

FIG. 4 shows a flowchart of the steps involved in validating local data on the central server while preserving privacy in a federated learning environment, in accordance with one or more embodiments.

FIG. 5 shows a flowchart of the steps involved in validating local data on the client device while preserving privacy in a federated learning environment, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

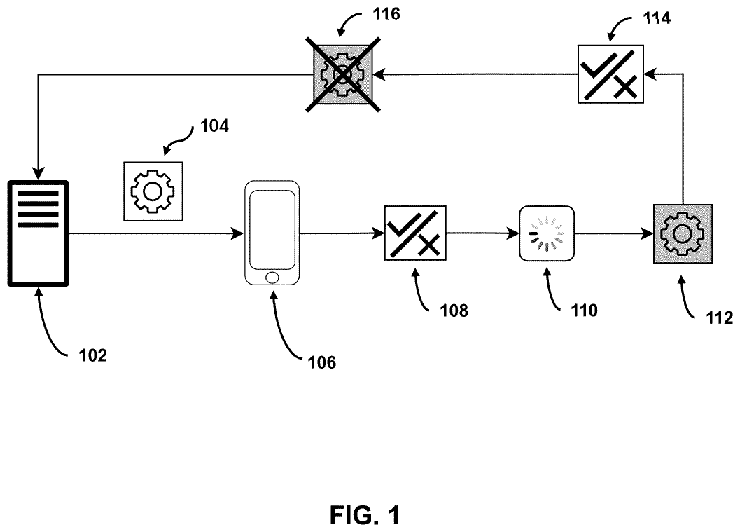

FIG. 1 shows an illustrative diagram for ensuring the accuracy of training data and improving the accuracy of the model in federated learning environments, in accordance with one or more embodiments. For example, system 100 may represent a federated learning environment. System 100 may represent the federated learning process involving only one client device (e.g., client device 106). In some embodiments, there may be one or more client devices participating in federated learning. In some embodiments, system 100 may include a central server (e.g., central server 102). In some embodiments, system 100 illustrates comparison 108, comparison 114, and determination 116 that preserve privacy in a federated learning environment while simultaneously validating and corroborating local data residing on a client device. For example, system 100 preserves the privacy of the user associated with the client device by not letting identifiable information be transmitted from the device. For example, the client device may de-identify user data prior to transmission thereby preserving the privacy of the user associated with the client device. As such, the system may prevent a client device from using inaccurate training data to train a local model in a federated learning environment without compromising the privacy of the user associated with the client device.

For example, central server 102 may be responsible for managing a global model and facilitating the distribution and aggregation of local models to one or more client devices in the federated learning environment. In some embodiments, central server 102 may store or be able to access the global model to be trained (e.g., model 104).

In some embodiments, central server 102 sends model 104 to client device 106. For example, model 104 may be the current global model managed by the central server. In some embodiments, once model 104 is received by client device 106 it may be referred to as a local model.

In some embodiments, after client device 106 receives model 104, client device 106 performs comparison 108. For example, comparison 108 might include comparing the local data and the event metadata to generate validated local data. In some embodiments, the event metadata corresponds to validation data and events in the local data.

In some embodiments, client device 106 performs model training using the validated local data in training 110. In some embodiments, after training, client device 106 generates de-identified event metadata based on the event metadata by using a de-identification function. For example, generating de-identified event metadata allows useful data to be preserved without identifying a user corresponding to client device 106.

In some embodiments, client device 106 transmits trained model 112 and the de-identified event metadata to central server 102. In some embodiments, central server 102 generates corroborating metadata corresponding to the events in the de-identified event metadata received from client device 106. In some embodiments, central server 102 compares the corroborating metadata and de-identified event metadata in comparison 114 to make determination 116. In some embodiments, determination 116 represents a decision to exclude the model from being included in the updated global model during aggregation. In some embodiments, despite being depicted as occurring prior to receipt on central server 102, comparison 114 and determination 116 can occur prior to or on central server 102.

The system may be used to train a global model in a federated learning environment. In disclosed embodiments, a global model may include a model to be trained by one or more client devices using local client device data while preserving privacy. In some embodiments, the global model may comprise a machine learning model that is managed by a central server. The global model may be distributed to one or more client devices to be trained using the local data on the client devices. The global model may be a model based on aggregated model updates from client devices that have transmitted trained models to the central server.

The system may be used to train a local model using local data. In disclosed embodiments, local data may include data residing on a client device that is not accessible outside of the device. For example, local data on a client device (e.g., client device 106) cannot be accessed by the central server (e.g., central server 102). In some embodiments, local data may comprise one or more databases storing information from one or more applications running on a client device. In some embodiments, local data may comprise transaction data or communication data.

The system may be used to generate validated local data using validation data. In disclosed embodiments, validation data may include data that is gathered from one or more external sources pertaining to local data on the client device. For example, validation data may include an external server storing transaction history or communication information associated with the client device. In some embodiments, the validation data may be accessible to a client device but inaccessible to the central server in a federated learning environment.

The system may be used to generate validated local data using event metadata. In disclosed embodiments, event metadata may include data that is the overlap between events in local data and the validation data. For example, event metadata may comprise messages transmitted from a messaging application on the client device and included in the validation gathered from the cloud storage corresponding to the messaging application on the client device. In some embodiments, event metadata may be used in conjunction with validated data to generate validated local data.

The system may be used to generate validated local data. In disclosed embodiments, validated local data may include the data used to train the local model received from the central server (e.g., model 104). In some embodiments, validated local data may be the local data that overlaps with event metadata. In some embodiments, the validated local data is inaccessible to the central server. In some embodiments, the validated local data is used to train the local model, which reduces the complications in training a model that stems from using inaccurate or incomplete local data on the client device.

The system may be used to generate de-identified metadata to transmit to the central server. In disclosed embodiments, de-identified metadata may include event metadata that has been processed to remove any information that can be used to identify a user associated with a client device. In some embodiments, the de-identified metadata may be transmitted to the central server in conjunction with the local model after training. For example, by using de-identified metadata in a federated learning environment, the central server can receive information about the local data on the client device without compromising the privacy of a user associated with a client device.

The system may be used to generate corroborating metadata. In disclosed embodiments, corroborating metadata may include data corresponding to events in de-identified metadata. In some embodiments, the system may exclude the local model from the model update based on comparing the corroborating metadata to the de-identified event metadata.

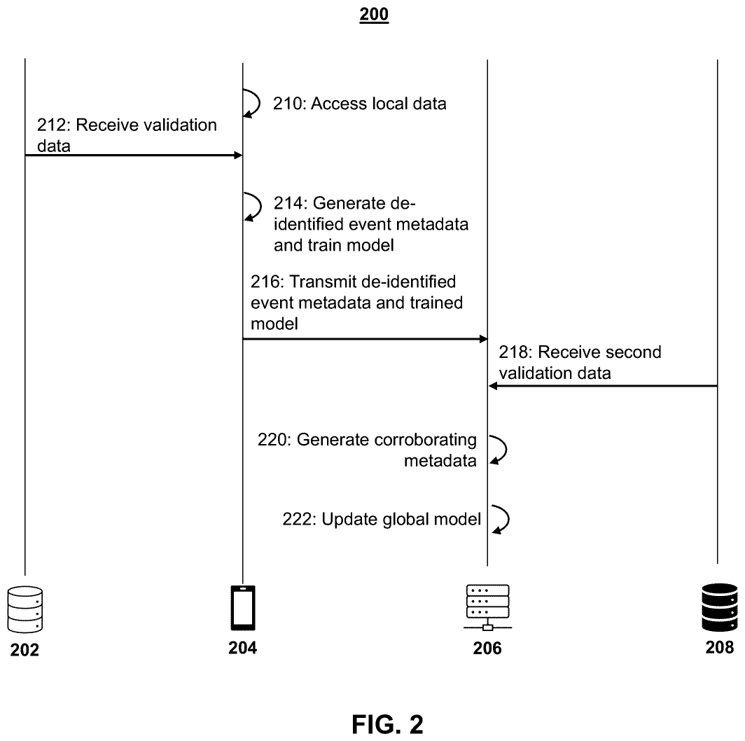

FIG. 2 shows an illustrative data flow diagram for validating local data on a client device prior to training, in accordance with one or more embodiments. System 200 may include external server 202, which may store validation data corresponding to the client device and be inaccessible to a central server (e.g., central server 206). System 200 may include client device 204, which may access external server 202 and which may communicate with central server 206. System 200 may include external server 208, which may store validation data for use by the central server and be inaccessible to the client device. Client device 204 may communicate with central server 206 to transmit or receive local models or local model updates. Client device 204 may be responsible for training a model received from central server 206. In some embodiments, central server 206 may access external server 208 to use validation data to determine whether to include a model transmitted by client device 204 in aggregation.

In step 210, client device 204 accesses the local data. In some embodiments, the local data may comprise information that is useful or necessary to train a machine learning model. For example, if a model for image processing is being trained using federated learning, a client device selected for training may include local data such as pictures captured by an integrated camera. As another example, if a model for recommendations is being trained using federated learning, a client device selected for training may include local data such as interactions with a content streaming application. In some embodiments, the local data residing on client device 204 is only accessible on client device 204. Specifically, the local data residing on client device 204 may not be accessible by central server 206.

In step 212, client device 204 receives validation data from external server 202. In some embodiments, external server 202 may include data from multiple sources. For example, these multiple sources may include sources that correspond to applications on the client device such as entertainment applications, messaging applications, or other applications residing on the client device. For example, multiple sources may include databases that store information about user actions in an entertainment application or databases that store information about user communications in a messaging application.

In step 214, client device 204 generates de-identified event metadata. In some embodiments, client device 204 may train a local model using the de-identified event metadata. For example, de-identified event metadata may include portions of the event metadata generated on client device 204 that does not identify a user associated with client device 204. As another example, de-identified event metadata may include event metadata that has been modified so it cannot identify a user associated with client device 204.

In step 216, client device 204 transmits the de-identified metadata and the model to central server 206. In some embodiments, transmitting the de-identified metadata and the model to central server 206 preserves the privacy of client device 204, which is especially important in federated learning environments.

In step 218, central server 206 receives second validation data from external server 208. In some embodiments, the second validation data may include information from external server 208 that corresponds to events in the de-identified event metadata. In some embodiments, the second validation data may be inaccessible to client device 204. For example, the second validation data may be data that is private or has limited accessibility for unauthorized users.

In step 220, central server 206 generates corroborating metadata on central server 206. In some embodiments, the corroborating metadata generated on central server 206 may be based on validation data received from external server 208. In some embodiments, the corroborating metadata corresponds to events in the de-identified event metadata received from the client device.

In step 222, central server 206 updates the global model. In some embodiments, updating the global model comprises averaging and aggregating the parameters of the local models transmitted by one or more client devices (e.g., in step 216 when client device 204 transmits the trained model to central server 206).

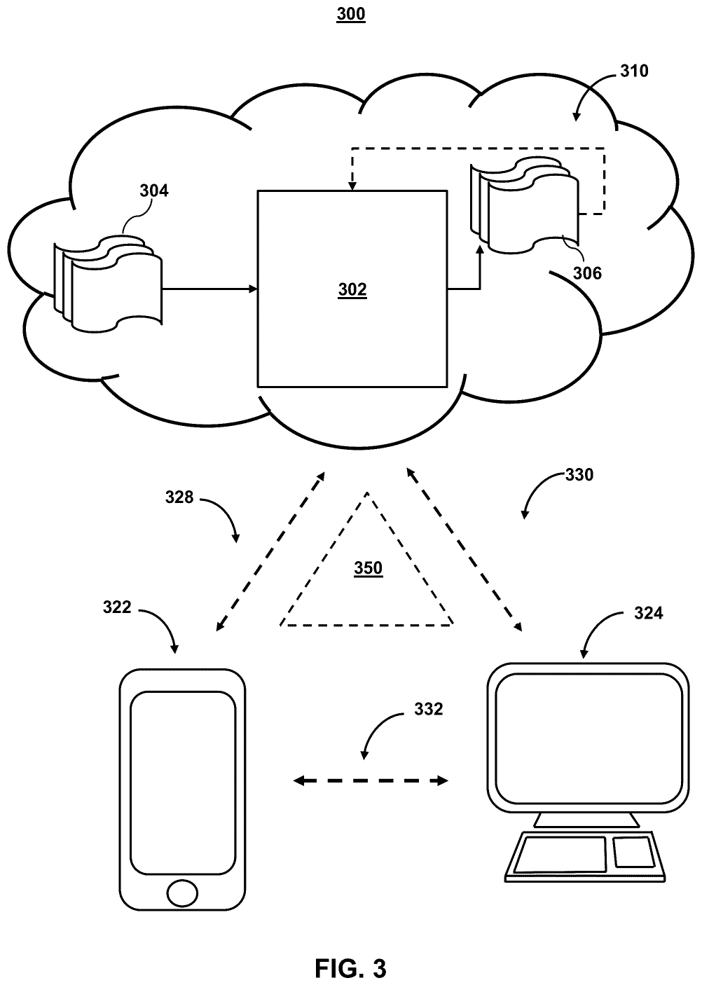

FIG. 3 shows illustrative components for a system used to prevent a client device from using inaccurate training data to train a local model in a federated learning environment, in accordance with one or more embodiments. For example, FIG. 3 may show illustrative components for validating local data used to train a local model at a client device and corroborating local data used to train a local model at the central server to improve the accuracy of the global model in federated learning environments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, mobile device 322 and user terminal 324 can also act as user input interfaces. It should be noted that in some embodiments, the devices may have neither user input interfaces nor displays and may instead receive and display content using another device (e.g., a dedicated display device such as a computer screen and/or a dedicated input device such as a remote control, a mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, virtual private networks, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include central server 102, client device 106, client device 204, or central server 206. Furthermore, cloud components 310 may access external server 202 or external server 208.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., validated by event metadata or not validated by event metadata, or exclude the model from the update or not exclude the model from the update).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem-solving as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., validated data or corroborated data).

In some embodiments, the model (e.g., model 302) may automatically perform actions based on outputs 306. In some embodiments, the model (e.g., model 302) may not perform any actions. The output of the model (e.g., model 302) may be used to determine whether to exclude a portion of the local data that is not validated by the event metadata on the local device. The output of the model may also be used to determine whether to exclude the local model from updates to a global model.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP web services have traditionally been adopted in the enterprise for publishing internal services as well as for exchanging information with partners in B2B transactions.

API layer 350 may use various architectural arrangements. For example, system 300 may be partially based on API layer 350, such that there is strong adoption of SOAP and RESTful web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer where microservices reside. In this kind of architecture, the role of the API layer 350 may provide integration between the front end and the back end. In such cases, API layer 350 may use RESTful APIs (exposition to the front end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API platforms and their modules. API layer 350 may use a developer portal. API layer 350 may use strong security constraints applying WAF and DDOS protection, and API layer 350 may use RESTful APIs as standard for external integration.

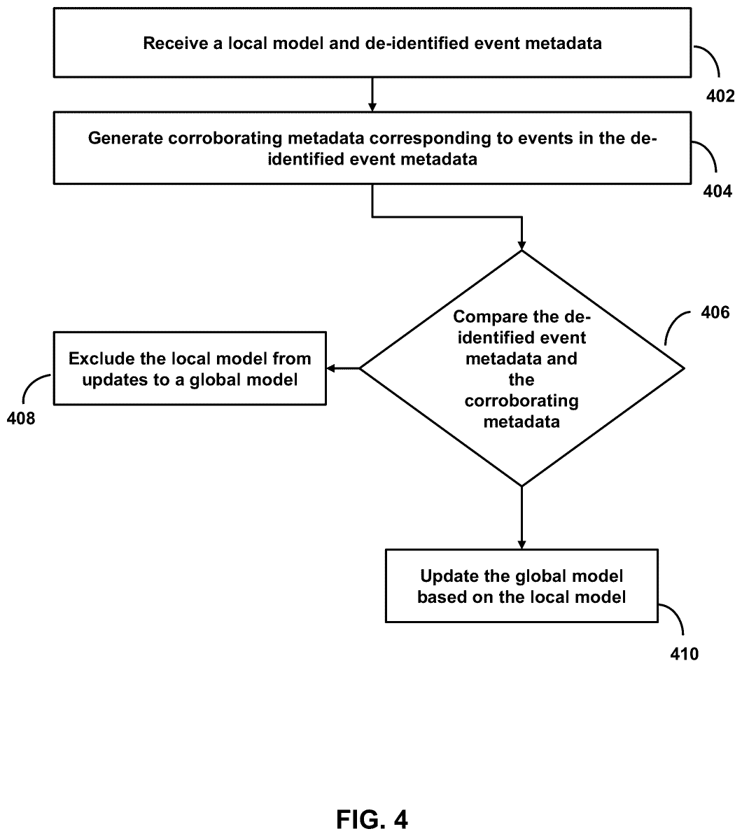

FIG. 4 shows a flowchart of the steps involved in validating local data on the central server while preserving privacy in a federated learning environment, in accordance with one or more embodiments. For example, the system may use process 400 (e.g., as implemented on one or more system components described above) in order to preserve the privacy of a user associated with a client device and validate and corroborate local data used to train a local model in a federated learning environment.

At step 402, process 400 (e.g., using one or more components described above) receives a local model and de-identified event metadata. For example, the system may receive, from a client device, a local model, and de-identified event metadata. For example, the central server may receive the local model that includes parameters used to train the model on the client device. For example, the central server may receive de-identified event metadata associated with the local model that may be used to determine whether to exclude the local model from updates to the global model. By doing so, the system may preserve the privacy of the user associated with the client device by only receiving the local model and de-identified event metadata.

At step 404, process 400 (e.g., using one or more components described above) generates corroborating metadata corresponding to events in the de-identified event metadata. For example, the system may generate, based on validation data received from an external server, corroborating metadata corresponding to events in the de-identified event metadata, wherein the validation data is related to the events in the de-identified event metadata, and wherein the validation data is inaccessible to the client device. For example, the system may generate corroborating metadata corresponding to events in the de-identified event metadata by accessing validation data on an external server. For example, the system may generate corroborating metadata by accessing telecommunications records that indicate metadata about a user's communication activity associated with a client device. By doing so, the system may ensure that the local model received from the client device corresponds to the corroborating metadata, thus improving the accuracy of the model.

At step 406, process 400 (e.g., using one or more components described above) compares the de-identified event metadata and the corroborating metadata. For example, the system may compare the de-identified event metadata and the corroborating metadata. For example, the system may identify attributes in the de-identified event metadata and the corroborating metadata and compare the attributes to determine that the attributes are inconsistent and therefore the local model will be excluded from updates to the global model. By doing so, the system may increase the accuracy during training by corroborating the information received from the client device prior to aggregating the local model with the global model.

In some embodiments, the system may determine whether to exclude the local model from updates based on additional attributes. For example, the system may identify a first plurality of attributes in the de-identified event metadata and identify a second plurality of attributes in the corroborating metadata. The system may determine whether to exclude the local model from updates to the global model based on a threshold number, wherein the threshold number comprises first attributes from the first plurality of attributes that match second attributes from the second plurality of attributes and exclude the local model from updates to the global model in response to determining that a number of the first attributes that match the second attributes is below the threshold number. For example, the system may identify first attributes in the de-identified event metadata. The first attributes may include the time spent on an application. For example, the first attributes may indicate that the client device had an application open for three minutes. The second attributes may correspond to generic usage data that indicates users spend on average 50 minutes on the application. By comparing the first attributes and the second attributes, the system may determine that the first attributes are not corroborated by the second attributes and thereby the central server will exclude the local model from updates to a global model.

At step 408, process 400 (e.g., using one or more components described above) excludes the local model from updates to a global model. For example, the system may determine to exclude the local model from updates to a global model. For example, based on determining that the attributes from the de-identified event metadata do not correspond to the corroborating metadata, the system may exclude the local model from updates to the global model. For example, if the model is a natural language processing model and the client device transmits de-identified event metadata related to communication data, but the corroborating metadata generated from a server corresponding to the application on the client device used for communication does not indicate any activity from the client device, the local model transmitted from the client device may be excluded from the updates to the global model. By doing so, the system may reduce the likelihood that an inaccurate model is aggregated during updates to the global model, thereby improving the accuracy of the update.

At step 410, process 400 (e.g., using one or more components described above) updates the global model based on the local model. For example, the system may update the global model based on the local model. For example, if the corroborated metadata corresponds to the de-identified event metadata, the system may include the local model received from the client device in updates to the global model. For example, at step 410 the data used to train the model will have been validated and the results of local model training will be corroborated, which maximizes the likelihood that the local model was trained using accurate local data. By doing so, the system may maximize the accuracy of the global model.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

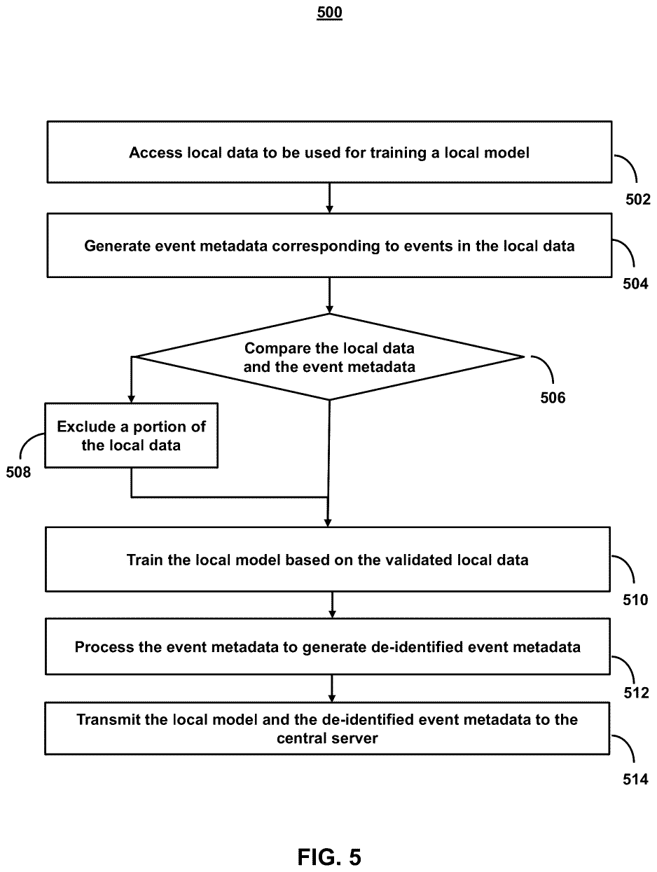

FIG. 5 shows a flowchart of the steps involved in validating local data on the client device while preserving privacy in a federated learning environment, in accordance with one or more embodiments. For example, the system may use process 500 (e.g., as implemented on one or more system components described above) in order to validate local data on the client device without transmitting the local data to a central server, thus preserving the privacy of the user associated with the client device, which is essential in federated learning applications.

At step 502, process 500 (e.g., using one or more components described above) accesses local data to be used for training a local model. For example, the system may access local data to be used for training a local model on a client device. For example, the client device may rely on local data to initiate local model training. For example, the system may access local data stored on a client device to train a local model. The local data may include sensitive data and non-sensitive data. For example, the local data may include message history, call history, location history, usage metrics, text messages, voicemail transcripts, stored documents, stored photos, stored videos, or stored audio recordings. By doing so, the system may ensure the local model is trained with real-world user data that resides on the client device, which avoids some of the complications in training with synthetic data such as low-quality or inaccurate data.

At step 504, process 500 (e.g., using one or more components described above) generates event metadata corresponding to events in the local data. For example, the system may generate, based on first validation data received from a first external server, event metadata corresponding to events in the local data, wherein the first validation data is related to the events in the local data, and wherein the first validation data is inaccessible to a central server. For example, in a communication application, the client device may generate event metadata corresponding to events in the local data such as metadata corresponding to incoming and outgoing communication events received from an external server that stores communication information that the client device can access (e.g., number of calls placed, duration of the call, number of voice messages received, or additional data pertaining to the communication application). By doing so, the system may be able to use the event metadata to improve the accuracy of model training.

In some embodiments, the system may generate event metadata based on relevant information from validation data. For example, the system may identify relevant information from the first validation data, wherein the relevant information comprises application data residing outside the client device that comprises data related to portions of data on the client device, identify data on the client device corresponding to the relevant information, and generate the event metadata pertaining to the application data on the client device corresponding to the relevant information. For example, the system may consider application data from the first validation data when identifying events in the local data. For example, the first validation data may include the number of times a specific feature on an application was used, the average length of time spent on a specific page of an application, the number of incoming or outgoing packets and the corresponding timestamps, and the total number of users. The events in the local data may include the application version, the duration the application was open, the local settings within the application, or the local usage data, including what buttons were pressed. By doing so, the system may ensure that the event metadata corresponds to the events in the local data, which may improve the accuracy of the model.

In some embodiments, the system may generate event data pertaining to relevant information. For example, the system may identify relevant information from the first validation data, wherein the relevant information comprises metadata pertaining to device information, identify the events in the local data on the client device, wherein the events in the local data on the client device correspond to the relevant information, and generate the event metadata pertaining to the relevant information. For example, the system may consider device information from the first validation data when identifying events in the local data. For example, the first validation data may include a heat map indicating where users are located, file modification history, or device information shared from the client device (such as operating system (OS), battery level, Internet Protocol (IP) address, or media access control (MAC) address). The events in the local data may include device location data (location of data modification, deletion, or access) or client device information (OS, battery level, IP address, or MAC address). By doing so, the system may ensure that the event data is relevant, which may increase the accuracy of the local model after training.

In some embodiments, the system may identify relevant information and corresponding local data to generate event metadata corresponding to the relevant information. For example, the system may identify relevant information from the first validation data, wherein the relevant information comprises metadata pertaining to communication data, identify data on the client device corresponding to the relevant information, and generate the event metadata pertaining to the relevant information. For example, the system may consider communication data from the first validation data when identifying events in the local data. For example, the first validation data may include phone numbers of the calling and called parties, time and duration of calls, IP addresses, or information about the device hardware. The events in the local data may include communication data such as the IP address of the client device, the number of texts sent or received, the number of missed phone calls, the number of placed phone calls, the number of voicemails, the number of unread messages, the average response duration, the average duration to answer the phone, the average number of texts a day, the average number of calls a day, or the amount of data used for a given period. By doing so, the system may generate relevant event metadata, which may lead to improved model accuracy.

At step 506, process 500 (e.g., using one or more components described above) compare the local data and the event metadata. For example, the system may compare the local data and the event metadata and generate validated local data. For example, the system may use the event metadata to ensure that the local data is accurate. For example, if a client device has local data that indicates the client device transmitted 10 megabytes of data through a communication application, but the event metadata corresponding to the communication shows 25 megabytes of data were transmitted, the local data may be inaccurate. As another example, the system may compare the local data and the event metadata to determine if the event metadata can validate the local data. If the event metadata cannot validate the local data, the system may determine that it is best to exclude a portion of the local data that is not able to be validated by the event metadata. The system may generate validated local data as a result of purging the local data of unreliable data. By doing so, the system may help ensure that the local data used to train the local model is accurate.

In some embodiments, the system may exclude the entire local model from the update if any data is not able to be validated by the event metadata. Furthermore, storing metadata information regarding the amount of local data excluded from the client device could be beneficial during federated learning. For example, if the stored metadata information regarding the amount of local data excluded from the client device is above a threshold, the system may determine that it is not beneficial to continue to use this client or accept model updates from the client. The threshold may be an absolute value or relative to the amount of data submitted. For example, if 70% of the local data on the client device is consistently excluded from updates to the central server, the system may determine that it is not beneficial to the system to continue assessing the local data of the client device.

At step 508, process 500 (e.g., using one or more components described above) excludes a portion of the local data. For example, the system may exclude a portion of the local data that is not validated by the event metadata. For example, if the event metadata and the local data do not coincide, the system may exclude the portion of the local data that does not coincide with the event metadata prior to training. By doing so, the system may ensure that only accurate local data is used to train a local model, thereby leading to increased training accuracy.

In some embodiments, the system may exclude portions of the local data based on similarities between event metadata and local data. For example, the system may identify a first attribute in the event metadata, identify a second attribute in the local data, and compare the first attribute and the second attribute by searching for a similarity between the first attribute and the second attribute that indicates the second attribute is accurate, determine that the first attribute does not validate the second attribute by determining that the first attribute and the second attribute do not share the similarity, and exclude unvalidated data from the local data used to train the local model. For example, the system may identify first attributes in the event metadata that includes information about the local data. The first attributes in the event metadata may include metadata such as application usage data, communication data, location data, or other data corresponding to the client device. The system may identify second attributes in the local data. The second attribute in the local data may include information from the event metadata, such as private information corresponding to application usage data, communication data, location data, or other data corresponding to the client device that does not identify the user of the device. The system may compare the first attributes and the second attributes and determine that the first attributes identified by the system can be proven to be true by comparing the first attributes to the second attributes. For example, the first attribute may be communication records indicating a device with a unique ID transmitted eight messages in the last hour. The second attribute may show that 10 messages were sent in the last hour. By comparing the first attribute and the second attribute and determining that the first attribute does not corroborate the second attribute, the system may disregard the communication data from the device when training the local model. By doing so, the system may refrain from using inaccurate data to train the local model, thereby improving the accuracy of the global model after updating.

At step 510, process 500 (e.g., using one or more components described above) trains the local model based on the validated local data. For example, the system may train the local model based on the validated local data. For example, after ensuring the local data is not disproven by the event metadata, the client device may use the validated local data to train the local model without corrupting the results with inaccurate training data. As another example, the system may train the local model on the client device using the validated local data as an input for the model. For example, the local model may be a model for image recognition, keyboard or speech recognition, prediction algorithms, natural language processing (NLP), recommender systems, ad targeting models, or threat detection. The local model may use local data on the client device such as image metadata, keyboard or dictation metadata, various application usage metadata, or device metadata. By doing so, the system may train a more accurate local model than if the local data used to train the model was not validated.

At step 512, process 500 (e.g., using one or more components described above) processes the event metadata to generate de-identified event metadata. For example, the system may process, using a data de-identification function, the event metadata to generate de-identified event metadata. For example, the system may remove any information that may identify a user associated with a client device prior to transmitting the local model to the central server. As another example, the system, based on the data used to train the model, may use a data de-identification function to generate de-identified event metadata. For example, if the event metadata contains non-public personal information (NPI) such as account balances, automated clearing house (ACH) numbers, bank account numbers, credit card numbers, credit ratings, date and/or location of birth, driver's license information, income history, payment history, Social Security numbers (SSNs), tax return information, names, addresses, or phone numbers, the system may remove or modify the data to create de-identified event metadata. By doing so, the system may preserve the privacy of the user associated with the client device, which is essential in federated learning environments.

In some embodiments, the system can perform metadata validation and training simultaneously or in a different order. For example, the system can train the model using the client's local data and as the training occurs the system can generate the event metadata, perform the comparison of the local data and the event metadata, and de-identify metadata and exclude data that is not validated by the event metadata. Alternatively, the system can train the model based on the local data and validate the local data after training occurs to exclude the update if the data is not validated by the event metadata.

In some embodiments, the data de-identification function includes generalizing sensitive information. For example, the system may identify sensitive information in the event metadata, wherein the sensitive information comprises information that is capable of being used to identify a user associated with the client device, determine that the sensitive information should be generalized, and generate non-sensitive metadata, wherein generating the non-sensitive metadata comprises generalizing the sensitive information in the event metadata, wherein generalizing the sensitive information in the event metadata comprises generating a group corresponding to a range of values in the sensitive information. The system may determine the group for a value in the sensitive information, wherein the group for the value is determined based on determining that the value falls within the range of values used when generating the group, and store the group instead of the value in the non-sensitive metadata. For example, the system may comprise a data de-identification function that identifies sensitive information in the event metadata. For example, the de-identification function may identify phone numbers, SSNs, addresses, or other NPI. The data de-identification function may determine what to do with sensitive information. Specifically, the data de-identification function may determine if the NPI identified in the event metadata should be generalized. For example, the data de-identification function may determine that ages should be generalized to the closest age group (e.g., 46 years old would be rounded to the age group 45-64). The system may perform this action and generate non-sensitive event metadata to transmit back to the central server for additional validation. By doing so, the system may preserve the privacy of the user associated with the client device.

In some embodiments, the data de-identification function includes randomizing sensitive information. For example, the system may identify sensitive information in the event metadata, wherein the sensitive information comprises information that is capable of being used to identify a user associated with the client device, determine that the sensitive information should be randomized, and generate non-sensitive metadata by randomizing the sensitive information in the event metadata, wherein randomizing the sensitive information in the event metadata comprises generating one or more values within a predetermined range to replace the sensitive information in the event metadata. For example, the system may comprise a data de-identification function that identifies sensitive information in the event metadata. For example, the de-identification function may identify phone numbers, SSNs, addresses, or other NPI. The data de-identification function may determine what to do with sensitive information. Specifically, the data de-identification function may determine if the NPI identified in the event metadata should be randomized. For example, the data de-identification function may determine that ages should be randomized to maintain the specificity of the data but remove the NPI (e.g., age may be randomized to within +/−five years. For example, an age of 15 may be randomized to 18). The system may perform this action and generate non-sensitive event metadata to transmit back to the central server for additional validation. By doing so, the system may preserve the privacy of the user associated with the client device.

In some embodiments, the data de-identification function includes anonymizing sensitive information. For example, the system may identify sensitive information in the event metadata, wherein the sensitive information comprises information that is capable of being used to identify a user associated with the client device, determine that the sensitive information should be anonymized, and generate non-sensitive metadata by anonymizing the sensitive information in the event metadata, wherein anonymizing the sensitive information in the event metadata comprises removing a portion of the sensitive information from the event metadata, and wherein removing the portion of the sensitive information from the event metadata renders the sensitive information incapable of being used to identify the user associated with the client device. For example, the system may comprise a data de-identification function that identifies sensitive information in the event metadata. For example, the de-identification function may identify phone numbers, SSNs, addresses, or other NPI. The data de-identification function may determine what to do with sensitive information. Specifically, the data de-identification function may determine if the NPI identified in the event metadata should be anonymized. For example, the data de-identification function may determine that certain components in the event metadata should be anonymized to remove NPI. For example, if the event metadata contains the name “John,” the de-identification function may remove only the name from the data. The system may perform this action and generate non-sensitive event metadata to transmit back to the central server for additional validation. By doing so, the system may preserve the privacy of the user associated with the client device.

In some embodiments, the data de-identification function includes removing sensitive information. For example, the system may identify sensitive information in the event metadata, wherein the sensitive information comprises information that is capable of being used to identify a user associated with the client device, determine that multiple portions of the sensitive information should be removed, and generate non-sensitive metadata by removing the multiple portions of the sensitive information in the event metadata. For example, the system may comprise a data de-identification function that identifies sensitive information in the event metadata. For example, the de-identification function may identify phone numbers, SSNs, addresses, or other NPI. The data de-identification function may determine what to do with sensitive information. Specifically, the data de-identification function may determine if the NPI identified in the event metadata should be removed. For example, the data de-identification function may determine that certain data in the event metadata should be removed to preserve the confidentiality of NPI (e.g., if there is data that, when used in conjunction with other data, can identify the user of the client device, the de-identification function may remove the corresponding data). The system may perform this action and generate non-sensitive event metadata to transmit back to the central server for additional validation. By doing so, the system may preserve the privacy of the user associated with the client device.

In some embodiments, the data de-identification function includes removing sensitive information. For example, the system may generate a sensitivity threshold, wherein the sensitivity threshold is based on a combination of information in the local data that is capable of being used to identify a user associated with the client device, determine a sensitivity metric, wherein the sensitivity metric is based on an amount of information contained in a subset of the local data that is capable of being used to identify the user associated with the client device, determine that the sensitivity metric meets or exceeds the sensitivity threshold, and exclude the subset of the local data with the sensitivity metric exceeding the sensitivity threshold. For example, the system may include the data de-identification function. For example, the local data may include information that, by itself, may not identify an individual associated with a client device but in conjunction may identify the client device. For example, the local data may comprise ZIP Code, gender, and birthday, which may be enough to identify an individual together but not separately. Thus, the system may determine a sensitivity threshold based on how much of the information can be used in conjunction with other information to identify a user of a client device. Additionally, the system may determine a sensitivity metric that indicates how sensitive each subset of the local data is (e.g., the ZIP Code may be more sensitive than the gender). If the system determines that a subset of the local data has an equal or higher sensitivity metric than the sensitivity threshold, the system may exclude the subset of the local data. By doing so, the system may preserve the privacy of the user associated with the client device.

At step 514, process 500 (e.g., using one or more components described above) transmits the local model and the de-identified event metadata to the central server. For example, the system may transmit the local model and the de-identified event metadata to the central server. For example, the client device may transmit the local model after training that includes the model parameters and the de-identified event metadata to be used for additional data verification on the central server. As another example, the system may transmit the local model after training and the newly generated de-identified event metadata to the central server for aggregation. For example, the system may train a local model and the output may be a set of updates. The updates may be sent to a central server that is responsible for managing the global model and aggregating the models and updates received by one or more client devices. By doing so, the system may ensure that a local model trained with accurate local data is transmitted in addition to the de-identified metadata to preserve the privacy of the user associated with the client device and increase the accuracy when updating the global model.

In some embodiments, the local model and de-identified event metadata may be sent to an aggregator. For example, the system may transmit the local model and the de-identified event metadata to an aggregator, wherein the aggregator validates and sends the local model and the de-identified event metadata to the central server to integrate with a global model, and wherein the validation comprises generating the validated local data. For example, the system may transmit the local model and the de-identified event metadata to an aggregator. The aggregator may be a server that is separate from the central server. The aggregator may collect local models and de-identified event metadata from multiple client devices. The aggregator may aggregate the values of the local models and perform additional validation on the de-identified event metadata. The aggregator may, after aggregating the model, transmit the results to the central server for integration with the global model. By doing so, the system may preserve the privacy of the user associated with the client device while allowing further validation of the data used to train the local model on the client device.

In some embodiments, an aggregator may be used to generate an average of parameters received from client devices. For example, the system may the generate an average of first parameters of the local model with second parameters of a second local model from a second client device and transmit the average to the central server for integration with the global model, wherein generating an average comprises averaging the first parameters of the local model and the second parameters of the second local model. For example, the system may average the local model parameters with parameters from a second local model and transmit the average of the parameters to the central server for integration with the global model. For example, a group of security cameras at a secured warehouse may be designed to identify specific actions. There may be two cameras, camera A and camera B. Both cameras may be trained locally based on images and videos gathered over a period of time. The cameras may share their local models with an aggregator without sharing the actual images or videos gathered. The aggregator may aggregate the updates from camera A and camera B and transmit the aggregated results to a central server. The central server may use the aggregated results to train the global model. The global model, now enhanced with the aggregated results, may be distributed by the central server back to the cameras so that both camera A and camera B can benefit from the training of the other. By doing so, the system may update the global model based on the local model parameters, which may improve the speed and accuracy of training the global model.

In some embodiments, the aggregation may be based on the weighted average of model parameters. For example, the system may collect the local model from the client device, collect a second local model from a second client device, combine first weights of the local model and second weights of the second local model using a weighted average, wherein using the weighted average comprises taking the weighted average of the first weights of the local model and the second weights of the second local model, and transmitting the weighted average to the central server for integration with the global model. For example, the system may aggregate based on the weighted average. For example, if there are two client devices A and B, and both have trained the local model using distinct datasets, then in order to aggregate the updates from these clients a weighted average can be used. To use the weighted average to aggregate the updates from these clients, the system can assign a weight to each of the client's local models based on the size of the dataset used for training, the quality of the model, or any other criterion that can differentiate the models. By doing so, the system may take into consideration more than one local model to improve the accuracy of the global model after aggregation.

In some embodiments, the aggregator resides on the central server and updates the global model. For example, the system may include an aggregator wherein the aggregator resides on the central server and the central server performs aggregation of the local model with local models from other client devices and updates the global model. For example, the system may use an aggregator that is integrated with the central server. For example, the central server would be responsible for aggregating the local models received from the client devices and also for integrating the aggregated local models with the global model. By integrating the aggregator into the central server, the system may observe efficiency benefits since the aggregator does not need to transmit anything to the central server. Additionally, by integrating the aggregator into the central server, the server may be easier to manage on a smaller scale or more cost-effective on a large scale.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 5.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for federated learning including validation of training data on client devices before training models based on the training data, the system comprising a client device, one or more first processors, and a first non-transitory, computer-readable medium storing first instructions that, when executed by the one or more first processors, cause first operations comprising accessing local data to be used for training a local model on the client device, generating, based on first validation data received from a first external server, event metadata corresponding to events in the local data, wherein the first validation data is related to the events in the local data, and wherein the first validation data is inaccessible to a central server, based on comparing the local data and the event metadata, determining to exclude a portion of the local data that is not validated by the event metadata, and generating validated local data, training the local model based on the validated local data, processing, using a data de-identification function, the event metadata to generate de-identified event metadata, transmitting the local model and the de-identified event metadata to the central server, and the central server comprising one or more second processors and a second non-transitory, computer-readable medium storing second instructions that, when executed by the one or more second processors, cause second operations comprising receiving, from the client device, the local model and the de-identified event metadata, generating, based on second validation data received from a second external server, corroborating metadata corresponding to the events in the de-identified event metadata, wherein the second validation data is related to the events in the de-identified event metadata, and wherein the second validation data is inaccessible to the client device, based on comparing the de-identified event metadata and the corroborating metadata, determining whether to exclude the local model from updates to a global model, and based on determining to not exclude the local model, updating the global model based on the local model.
2. The method of the preceding embodiment, wherein based on comparing the de-identified event metadata and the corroborating metadata, determining whether to exclude the local model from updates to the global model further comprises identifying a first plurality of attributes in the de-identified event metadata, identifying a second plurality of attributes in the corroborating metadata, and determining whether to exclude the local model from updates to the global model based on determining whether a number of first attributes from the first plurality of attributes that match second attributes from the second plurality of attributes is below a threshold.
3. A method for federated learning including validation of training data on client devices before training models based on the training data, the method comprising accessing local data to be used for training a local model on a client device, generating, based on first validation data received from a first external server, event metadata corresponding to events in the local data, wherein the first validation data is related to the events in the local data, and wherein the first validation data is inaccessible to a central server, based on comparing the local data and the event metadata, determining to exclude a portion of the local data that is not validated by the event metadata, and generating validated local data, training the local model based on the validated local data, processing, using a data de-identification function, the event metadata to generate de-identified event metadata, and transmitting the local model and the de-identified event metadata to the central server.
4. The method of any one of the preceding embodiments, wherein the data de-identification function further comprises identifying sensitive information in the event metadata, wherein the sensitive information comprises information that is capable of being used to identify a user associated with the client device, determining that the sensitive information should be generalized, generating non-sensitive metadata, wherein generating the non-sensitive metadata comprises generalizing the sensitive information in the event metadata, wherein generalizing the sensitive information in the event metadata comprises generating a group corresponding to a range of values in the sensitive information, determining the group for a value in the sensitive information, wherein the group for the value is determined based on determining that the value falls within the range of values used when generating the group, and storing the group instead of the value in the non-sensitive metadata.
5. The method of any one of the preceding embodiments, wherein processing, using the data de-identification function, the event metadata to generate the de-identified event metadata comprises identifying sensitive information in the event metadata, wherein the sensitive information comprises information that is capable of being used to identify a user associated with the client device, determining that the sensitive information should be randomized, and generating non-sensitive metadata by randomizing the sensitive information in the event metadata, wherein randomizing the sensitive information in the event metadata comprises generating one or more values within a predetermined range to replace the sensitive information in the event metadata.
6. The method of any one of the preceding embodiments, wherein processing, using the data de-identification function, the event metadata to generate the de-identified event metadata comprises identifying sensitive information in the event metadata, wherein the sensitive information comprises information that is capable of being used to identify a user associated with the client device, determining that the sensitive information should be anonymized, and generating non-sensitive metadata by anonymizing the sensitive information in the event metadata, wherein anonymizing the sensitive information in the event metadata comprises removing a portion of the sensitive information from the event metadata, and wherein removing the portion of the sensitive information from the event metadata renders the sensitive information incapable of being used to identify the user associated with the client device.
7. The method of any one of the preceding embodiments, wherein processing, using the data de-identification function, the event metadata to generate the de-identified event metadata comprises identifying sensitive information in the event metadata, wherein the sensitive information comprises information that is capable of being used to identify a user associated with the client device, determining that multiple portions of the sensitive information should be removed, and generating non-sensitive metadata by removing the multiple portions of the sensitive information in the event metadata.
8. The method of any one of the preceding embodiments, wherein processing, using the data de-identification function, the event metadata to generate the de-identified event metadata comprises generating a sensitivity threshold, wherein the sensitivity threshold is based on a combination of information in the local data that is capable of being used to identify a user associated with the client device, determining a sensitivity metric, wherein the sensitivity metric is based on an amount of information contained in a subset of the local data that is capable of being used to identify the user associated with the client device, determining that the sensitivity metric meets or exceeds the sensitivity threshold, and excluding the subset of the local data with the sensitivity metric exceeding the sensitivity threshold.
9. The method of any one of the preceding embodiments, wherein determining to exclude the portion of the local data that is not validated by the event metadata further comprises identifying a first attribute in the event metadata, identifying a second attribute in the local data, comparing the first attribute and the second attribute by searching for a similarity between the first attribute and the second attribute that indicates the second attribute is accurate, determining that the first attribute does not validate the second attribute by determining that the first attribute and the second attribute do not share the similarity, and excluding unvalidated data from the local data used to train the local model.
10. The method of any one of the preceding embodiments, wherein transmitting the local model and the de-identified event metadata to the central server comprises transmitting the local model and the de-identified event metadata to an aggregator, wherein the aggregator validates and sends the local model and the de-identified event metadata to the central server to integrate with a global model, and wherein the validation comprises generating the validated local data.
11. The method of any one of the preceding embodiments, wherein the aggregator generates an average of first parameters of the local model with second parameters of a second local model from a second client device and transmits the average to the central server for integration with the global model, wherein generating an average comprises averaging the first parameters of the local model and the second parameters of the second local model.
12. The method of any one of the preceding embodiments, wherein the aggregator collects the local model from the client device, collects a second local model from a second client device, combines first weights of the local model and second weights of the second local model using a weighted average, wherein using the weighted average comprises taking the weighted average of the first weights of the local model and the second weights of the second local model, and transmits the weighted average to the central server for integration with the global model.
13. The method of any one of the preceding embodiments, wherein the aggregator resides on the central server and the central server performs aggregation of the local model with local models from other client devices and updates the global model.
14. The method of any one of the preceding embodiments, wherein generating event metadata corresponding to the events in the local data comprises identifying relevant information from the first validation data, wherein the relevant information comprises application data residing outside the client device that comprises data related to portions of data on the client device, identifying data on the client device corresponding to the relevant information, and generating the event metadata pertaining to the application data on the client device corresponding to the relevant information.
15. The method of any one of the preceding embodiments, wherein generating event metadata corresponding to the events in the local data comprises identifying relevant information from the first validation data, wherein the relevant information comprises metadata pertaining to device information, identifying the events in the local data on the client device, wherein the events in the local data on the client device correspond to the relevant information, and generating the event metadata pertaining to the relevant information.
16. The method of any one of the preceding embodiments, wherein generating event metadata corresponding to the events in the local data further comprises identifying relevant information from the first validation data, wherein the relevant information comprises metadata pertaining to communication data, identifying data on the client device corresponding to the relevant information, and generating the event metadata pertaining to the relevant information.
17. A non-transitory, computer-readable medium storing instructions that, when executed by a data processing apparatus, cause the data processing apparatus to perform operations comprising those of any of embodiments 1-16.
18. A system comprising one or more processors; and memory storing instructions that, when executed by the processors, cause the processors to effectuate operations comprising those of any of embodiments 1-16.
19. A system comprising means for performing any of embodiments 1-16.

What is claimed is:

1. A system for federated learning including validation of training data on client devices before training models based on the training data, the system comprising:
a client device, one or more first processors, and a first non-transitory, computer-readable medium storing first instructions that, when executed by the one or more first processors, cause first operations comprising:
accessing local data to be used for training a local model on the client device;
generating, based on first validation data received from a first external server, event metadata corresponding to events in the local data, wherein the first validation data is related to the events in the local data, and wherein the first validation data is inaccessible to a central server;
based on comparing the local data and the event metadata, determining to exclude a portion of the local data that is not validated by the event metadata, and generating validated local data;
training the local model based on the validated local data;
processing, using a data de-identification function, the event metadata to generate de-identified event metadata;
transmitting the local model and the de-identified event metadata to the central server; and
the central server comprising one or more second processors and a second non-transitory, computer-readable medium storing second instructions that, when executed by the one or more second processors, cause second operations comprising:
receiving, from the client device, the local model and the de-identified event metadata;
generating, based on second validation data received from a second external server, corroborating metadata corresponding to the events in the de-identified event metadata, wherein the second validation data is related to the events in the de-identified event metadata, and wherein the second validation data is inaccessible to the client device;
based on comparing the de-identified event metadata and the corroborating metadata, determining whether to exclude the local model from updates to a global model; and
based on determining to not exclude the local model, updating the global model based on the local model.

2. The system of claim 1, wherein based on comparing the de-identified event metadata and the corroborating metadata, determining whether to exclude the local model from updates to the global model further comprises:
identifying a first plurality of attributes in the de-identified event metadata;
identifying a second plurality of attributes in the corroborating metadata; and
determining whether to exclude the local model from updates to the global model based on determining whether a number of first attributes from the first plurality of attributes that match second attributes from the second plurality of attributes is below a threshold.

3. A method for federated learning including validation of training data on client devices before training models based on the training data, the method comprising:
accessing local data to be used for training a local model on a client device;
generating, based on first validation data received from a first external server, event metadata corresponding to events in the local data, wherein the first validation data is related to the events in the local data, and wherein the first validation data is inaccessible to a central server;
based on comparing the local data and the event metadata, determining to exclude a portion of the local data that is not validated by the event metadata, and generating validated local data;
training the local model based on the validated local data;
processing, using a data de-identification function, the event metadata to generate de-identified event metadata; and
transmitting the local model and the de-identified event metadata to the central server.

4. The method of claim 3, wherein processing, using the data de-identification function, the event metadata to generate the de-identified event metadata further comprises:
identifying sensitive information in the event metadata, wherein the sensitive information comprises information that is capable of being used to identify a user associated with the client device;
determining that the sensitive information should be generalized;
generating non-sensitive metadata, wherein generating the non-sensitive metadata comprises generalizing the sensitive information in the event metadata, wherein generalizing the sensitive information in the event metadata comprises generating a group corresponding to a range of values in the sensitive information;
determining the group for a value in the sensitive information, wherein the group for the value is determined based on determining that the value falls within the range of values used when generating the group; and
storing the group instead of the value in the non-sensitive metadata.

5. The method of claim 3, wherein processing, using the data de-identification function, the event metadata to generate the de-identified event metadata comprises:
identifying sensitive information in the event metadata, wherein the sensitive information comprises information that is capable of being used to identify a user associated with the client device;
determining that the sensitive information should be randomized; and
generating non-sensitive metadata by randomizing the sensitive information in the event metadata, wherein randomizing the sensitive information in the event metadata comprises generating one or more values within a predetermined range to replace the sensitive information in the event metadata.

6. The method of claim 3, wherein processing, using the data de-identification function, the event metadata to generate the de-identified event metadata comprises:
identifying sensitive information in the event metadata, wherein the sensitive information comprises information that is capable of being used to identify a user associated with the client device;
determining that the sensitive information should be anonymized; and
generating non-sensitive metadata by anonymizing the sensitive information in the event metadata, wherein anonymizing the sensitive information in the event metadata comprises removing a portion of the sensitive information from the event metadata, and wherein removing the portion of the sensitive information from the event metadata renders the sensitive information incapable of being used to identify the user associated with the client device.

7. The method of claim 3, wherein processing, using the data de-identification function, the event metadata to generate the de-identified event metadata comprises:
identifying sensitive information in the event metadata, wherein the sensitive information comprises information that is capable of being used to identify a user associated with the client device;
determining that multiple portions of the sensitive information should be removed; and
generating non-sensitive metadata by removing the multiple portions of the sensitive information in the event metadata.

8. The method of claim 3, wherein processing, using the data de-identification function, the event metadata to generate the de-identified event metadata comprises:
generating a sensitivity threshold, wherein the sensitivity threshold is based on a combination of information in the local data that is capable of being used to identify a user associated with the client device;
determining a sensitivity metric, wherein the sensitivity metric is based on an amount of information contained in a subset of the local data that is capable of being used to identify the user associated with the client device;
determining that the sensitivity metric meets or exceeds the sensitivity threshold; and
excluding the subset of the local data with the sensitivity metric exceeding the sensitivity threshold.

9. The method of claim 3, wherein determining to exclude the portion of the local data that is not validated by the event metadata further comprises:
identifying a first attribute in the event metadata;
identifying a second attribute in the local data;
comparing the first attribute and the second attribute by searching for a similarity between the first attribute and the second attribute that indicates the second attribute is accurate;
determining that the first attribute does not validate the second attribute by determining that the first attribute and the second attribute do not share the similarity; and
excluding unvalidated data from the local data used to train the local model.

10. The method of claim 3, wherein transmitting the local model and the de-identified event metadata to the central server comprises transmitting the local model and the de-identified event metadata to an aggregator, wherein the aggregator validates and sends the local model and the de-identified event metadata to the central server to integrate with a global model, and wherein the validation comprises generating the validated local data.

11. The method of claim 10, wherein the aggregator generates an average of first parameters of the local model with second parameters of a second local model from a second client device and transmits the average to the central server for integration with the global model, wherein generating an average comprises averaging the first parameters of the local model and the second parameters of the second local model.

12. The method of claim 10, wherein the aggregator collects the local model from the client device, collects a second local model from a second client device, combines first weights of the local model and second weights of the second local model using a weighted average, wherein using the weighted average comprises taking the weighted average of the first weights of the local model and the second weights of the second local model, and transmits the weighted average to the central server for integration with the global model.

13. The method of claim 10, wherein the aggregator resides on the central server and the central server performs aggregation of the local model with local models from other client devices and updates the global model.

14. The method of claim 3, wherein generating event metadata corresponding to the events in the local data comprises:
identifying relevant information from the first validation data, wherein the relevant information comprises application data residing outside the client device that comprises data related to portions of data on the client device;
identifying data on the client device corresponding to the relevant information; and
generating the event metadata pertaining to the application data on the client device corresponding to the relevant information.

15. The method of claim 3, wherein generating event metadata corresponding to the events in the local data comprises:
identifying relevant information from the first validation data, wherein the relevant information comprises metadata pertaining to device information;
identifying the events in the local data on the client device, wherein the events in the local data on the client device correspond to the relevant information; and
generating the event metadata pertaining to the relevant information.

16. The method of claim 3, wherein generating event metadata corresponding to the events in the local data further comprises:
identifying relevant information from the first validation data, wherein the relevant information comprises metadata pertaining to communication data;
identifying data on the client device corresponding to the relevant information; and
generating the event metadata pertaining to the relevant information.

17. A non-transitory, computer-readable medium comprising instructions recorded thereon that when executed by one or more processors causes operations comprising:
receiving, from a client device, a local model and de-identified event metadata;
generating, based on validation data received from an external server, corroborating metadata corresponding to events in the de-identified event metadata, wherein the validation data is related to the events in the de-identified event metadata, and wherein the validation data is inaccessible to the client device;
based on comparing the de-identified event metadata and the corroborating metadata, determining whether to exclude the local model from updates to a global model; and
based on determining to not exclude the local model, updating the global model based on the local model.

18. The non-transitory, computer-readable medium of claim 17, wherein comparing the de-identified event metadata and the corroborating metadata further comprises:
identifying a first attribute in the de-identified event metadata;
identifying a second attribute in the corroborating metadata; and
comparing the first attribute and the second attribute by searching for a similarity between the first attribute and the second attribute that indicates the first attribute is accurate.

19. The non-transitory, computer-readable medium of claim 17, wherein generating the corroborating metadata corresponding to the events in the de-identified event metadata further comprises:
identifying relevant information from the validation data, wherein the relevant information comprises application data residing outside the client device that comprises data related to portions of data on the client device;
identifying data on the client device corresponding to the relevant information; and
generating the corroborating metadata pertaining to the application data on the client device corresponding to the relevant information.

20. The non-transitory, computer-readable medium of claim 17, wherein generating the corroborating metadata corresponding to the events in the de-identified event metadata further comprises:
identifying relevant information from the validation data, wherein the relevant information comprises metadata pertaining to device information;
identifying data in the de-identified event metadata corresponding to the relevant information; and
generating the corroborating metadata pertaining to the de-identified event metadata corresponding to the relevant information, wherein the corroborating metadata comprises identifying similarities between the de-identified event metadata and the relevant information.
